(19) United States
(12) Patent Application Publication
(10) Pub. No.: US 2006/0118349 A1
(43) Pub. Date: Jun. 8, 2006

(54) Power plant for vehicles

(76) Inventors: James C. LeBlanc Sr, Rochester, MI (US); James C. LeBlanc Jr, Washington, MI (US); David A. Jackson, Washington, MI (US)

Correspondence Address: Peter N Lalos;Stevens Davis Miller & Mosher, Suite 850, 1615 L Street NW, Washington, DC, 20036-5622, US

(21) Appl. No.: 10/524,533

(22) PCT Filed: Jan. 16, 2004
(86) PCT No.: PCT/US04/01011

§ 371 Date: Oct. 13, 2005

(51) Int. Cl. B62D 21/00

(52) U.S. Cl. 180/312

(57) ABSTRACT

A vehicle consisting generally of a set of wheel assemblies, a body mounted on such wheel assemblies, a steering system mounted on such body and operatively connected to at least one of the wheel assemblies, a module removably mounted on the body including a support structure and a power plant mounted on the support structure and means for transmitting drive from the power plant to at least one of the wheel assemblies when the module is mounted on the vehicle, including means for disconnecting the power plant from the drive transmitting means.

This invention relates to vehicles and more particularly to a novel power plant arrangement for vehicles.

### BACKGROUND OF THE INVENTION

A type of vehicle prevalent in the prior art generally consists of a set of wheel units, a body of monocoque construction supported on such set of wheel units, a power plant and driveline mounted on the body and operatively connected to the wheel units, a steering system also mounted on the body and operatively connected to one or more of the wheel units, and possibly other ancillary systems and components. Such vehicles further may be provided with 4×4, 6×6, 8×8 and 10×10 wheel configurations and used for a variety of purposes. The type of such vehicles and its constituent component systems are illustrated and described in International Patent Applications Nos. PCT/US03/31228 entitled Wheel Unit for Automotive Vehicles, PCT/US03/31307 entitled Power Plant and Driveline for Vehicles, and PCT/US03/31305 entitled Steering System for Vehicles, all of which were filed on Oct. 3, 2003, and which are incorporated herein by reference.

In such type of vehicle, it typically is required to periodically obtain access to the power plant thereof for regular maintenance, repair or even replacement purposes. Often, certain maintenance and repair functions can be performed with the power plant remaining installed in the vehicle. In some instances, however, particularly when the power plant is to be replaced, it is required to entirely remove it from the vehicle. Because of the nature of such vehicles including limited space conditions and the location of such units, it often is difficult to gain access to different areas of such units installed in the vehicles without dismantling portions of the vehicle which burdens and complicates the function being performed. Also, because of the manner in which such power plants are positioned and secured to the bodies of such vehicles, it generally is difficult to readily and efficiently remove such power plants from the vehicles, situate them for maintenance and/or repair and then conveniently reinstall them, or replace them with replacement units.

Accordingly, it is the principal object of the present invention to provide a power plant of a vehicle and particularly a vehicle having a body of monocoque construction which may be readily and efficiently removed from such vehicle for maintenance or repair and reinstalled or replaced. It is a further object of the present invention to provide such a power plant installed in the vehicle which provides greater access to the unit for less extensive repair purposes, onsite.

### SUMMARY OF THE INVENTION

The objects of the invention are achieved by providing a module removably mountable on a vehicle of the type described, generally consisting of a support structure removably mountable on the body of the vehicle, a power plant mounted on such support structure and disconnectable means for coupling such power plant to the driveline of the vehicle when the module is mounted on the body. Preferably, the power plant consists of an engine mounted on the support structure, a transmission mounted on and depending from the underside of the engine and a transfer case operatively interconnecting an output shaft of the engine and an input shaft of the transmission. The support structure further is provided with means cooperable with components of the vehicle body for guiding the module into and out of position within the power plant compartment of the vehicle. The support structure of the module further is provided with surfaces engageable by clamping devices provided on the vehicle body for detachably retaining the module in position within the power plant compartment of the vehicle.

### BRIEF DESCRIPTION OF THE DRAWINGS

FIG. 1 is a perspective view of a vehicle having a 10×10 wheel configuration, equipped with a power plant embodying the present invention;

FIG. 2 is a view similar to the view shown in FIG. 1, illustrating the body and wheel units of the vehicle in phantom lines and the power plant module and driveline components in solid lines;

FIG. 3 is an enlarged, cross-sectional view taken along line 3-3 in FIG. 2, illustrating the power plant module positioned in the engine compartment of the vehicle;

FIG. 4 is a top plan view of a portion of the vehicle, illustrating the power plant module positioned in the engine compartment of the vehicle;

FIG. 5 is a perspective view a portion of the vehicle shown in FIGS. 1 and 2, illustrating the power plant module of the vehicle being removed from the engine compartment thereof;

FIG. 6 is a perspective view of the power plant module of the vehicle shown in FIGS. 2 through 5;

FIG. 7 is a side view of the module shown in FIG. 6;

FIG. 8 is an elevational view of the front end of the module shown in FIG. 6;

FIG. 9 is an elevational view of the rear side of the power plant module shown in FIG. 6;

FIG. 10 is a perspective view of the support structure of the power plant module shown in FIGS. 6 through 9;

FIG. 11 is a side elevational view of the power plant, illustrating its position relative to the axle positions of a vehicle having a 4×4 wheel configuration;

FIG. 12 is a side elevational view of the power plant, illustrating its position relative to the axle positions of a vehicle having a 6×6 wheel configuration;

FIG. 13 is a side elevational view of the power plant, illustrating its position relative to the axle positions of a vehicle having an 8×8 wheel configuration;

FIG. 14 is a side elevational view of the power plant, illustrating an alternative position of the power plant relative to the wheel positions of a vehicle having an 8×8 wheel configuration;

FIG. 15 is a side elevational view of the power plant, illustrating the position of the power plant relative to the axle positions of a vehicle having a 10×10 wheel configuration;

FIG. 16 is an enlarged, fragmentary view of the arrangement shown in FIG. 15, indicated by the reference numeral 16, illustrating the detachable coupling of the output shaft of the transmission with an input shaft of a transfer case;

FIG. 17 is an enlarged perspective view of the disconnectable coupling shown in FIG. 16;

FIG. 18 is another perspective view of the coupling shown in FIG. 17, illustrating the components thereof in exploded relation;

FIG. 19 is a side elevational view of portions of the vehicle and the power plant module, illustrating the manner in which the module is positioned on the floor of the vehicle body within the engine compartment;

FIG. 19a is a perspective view of the upper portion of the positioning members shown in FIG. 19;

FIG. 19b is an enlarged, elevational view of a positioning member and an associated leg member as shown in FIG. 19, illustrating the manner in which the leg member is lowered onto the positioning member;

FIG. 20 is a fragmentary, side elevational view of the power plant module, illustrating a mechanism utilized to detachably clamp the module to the floor of the vehicle body within the engine compartment;

FIG. 21 is an enlarged, side elevational view of the retaining mechanism shown in FIG. 20, illustrating the mechanism in an unclamping condition;

FIG. 22 is a view similar to the view shown in FIG. 21, illustrating the mechanism is a clamping condition; and

FIG. 23 is a perspective view of the mechanism shown in FIGS. 21 and 22, illustrating the components in exploded relation.

### DESCRIPTION OF PREFERRED EMBODIMENTS OF THE INVENTION

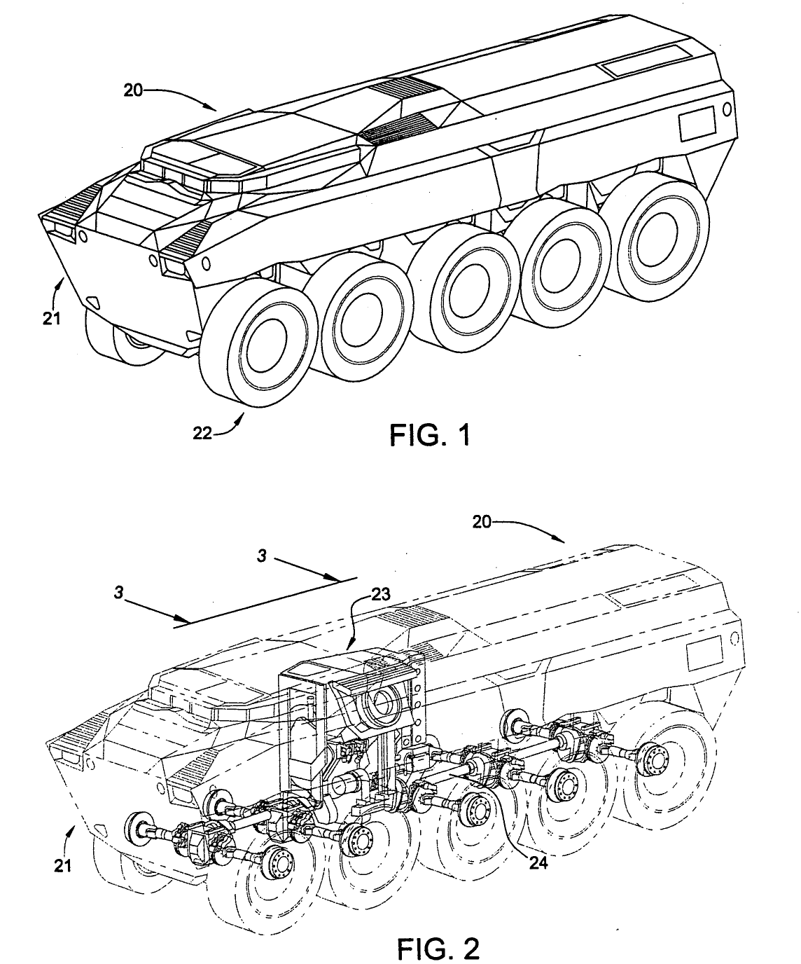

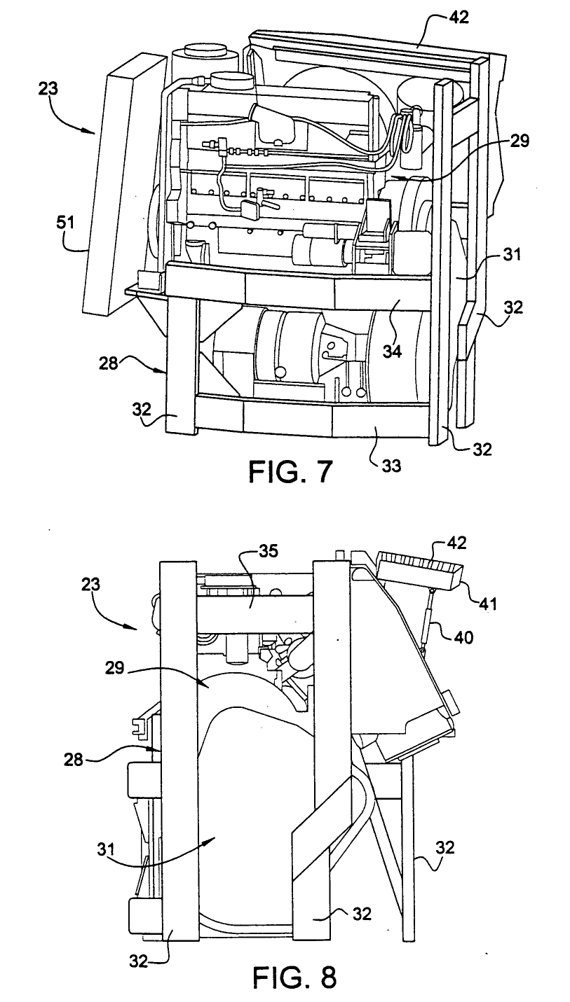

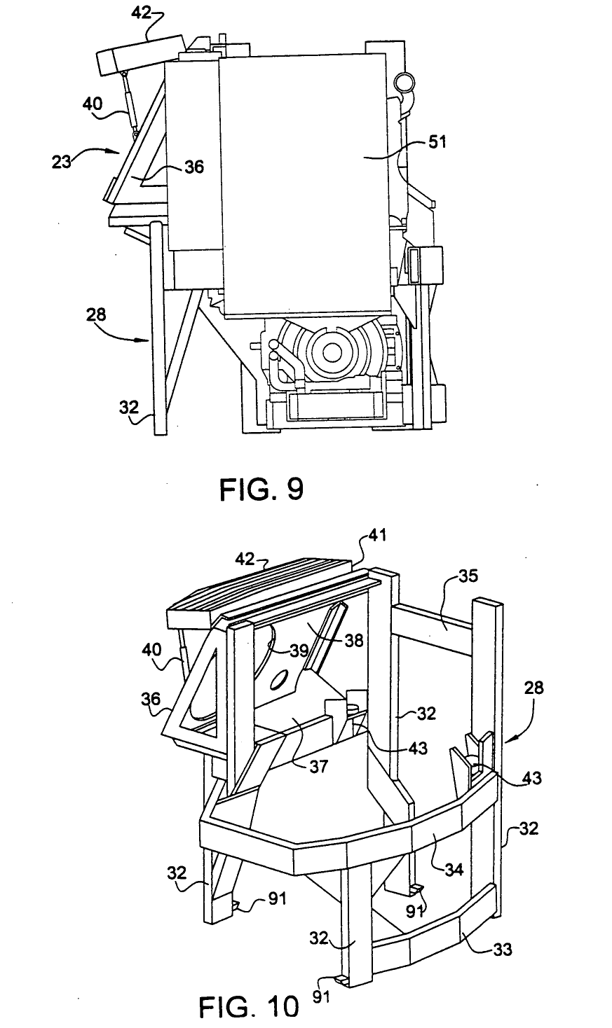

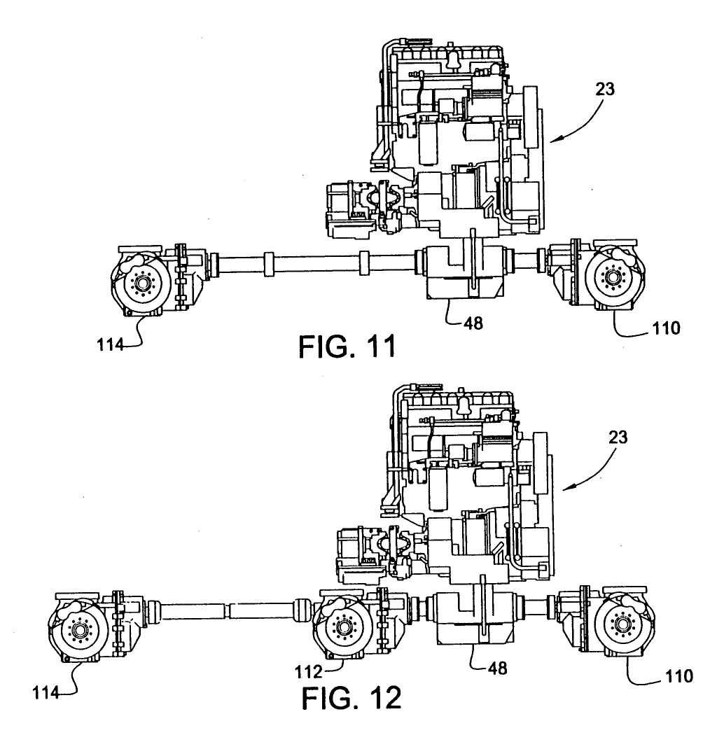

Referring to FIGS. 1 through 10 of the drawings, there is provided an automotive vehicle 20 generally consisting of a monocoque body or hull 21 mounted on a set of wheel units 22, a power plant module 23 mounted within the body, a driveline 24 for transmitting drive from the power plant module to the wheel units, a steering system mounted on the body and operatively connected to the steering wheel units and various other ancillary equipment and systems. The wheel units are of a type as illustrated and described in aforementioned PCT Application No. PCT/US03/31228, and the steering system is of the type as illustrated and described in aforementioned PCT Patent Application No. PCT/US03/31305. The underside of the hull is provided with five longitudinally spaced, transversely disposed recesses each opening into wheel wells to accommodate five wheel units and thus provide a vehicle with a 10×10 wheel configuration.

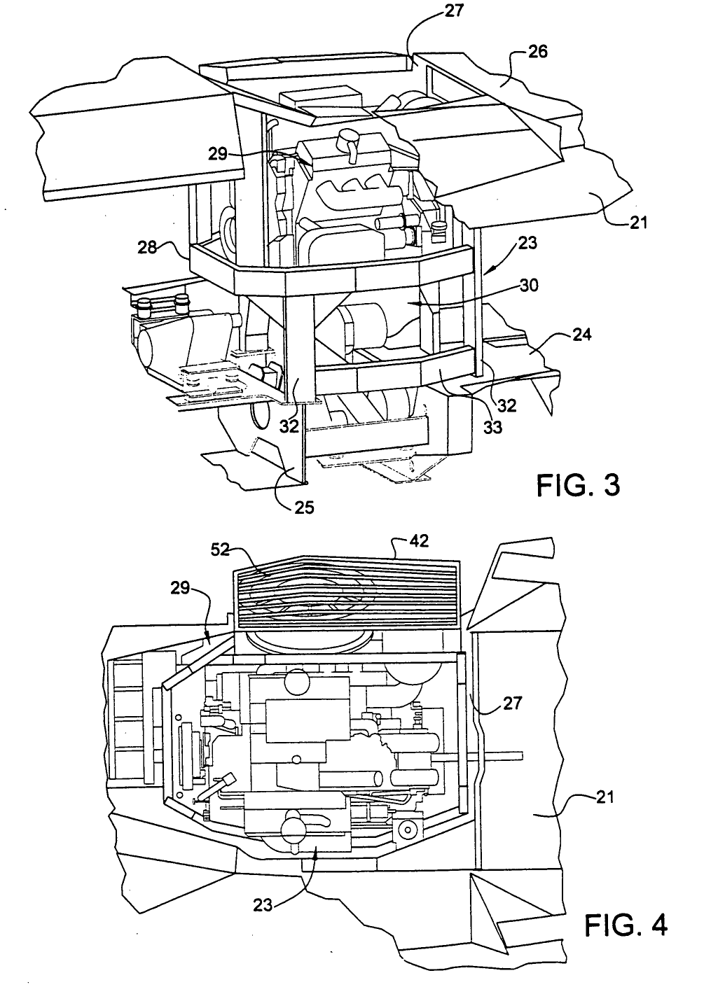

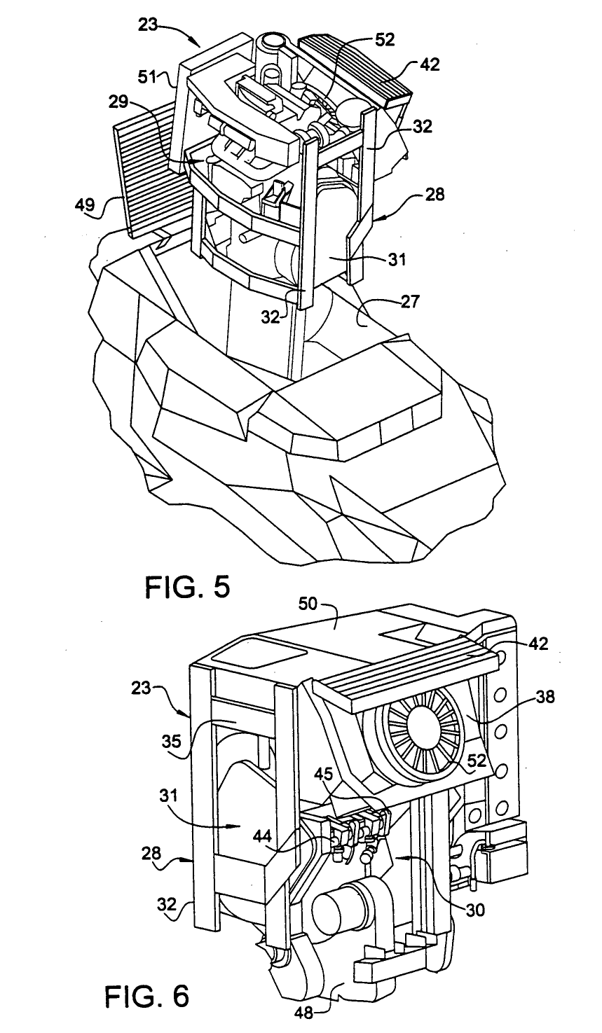

As best shown in FIGS. 3 through 5, the vehicle body is provided with a floor 24 supported on a number of longitudinally spaced, transversely disposed plate members 25 partially defining transverse openings accommodating the axle assemblies of the vehicle, and a roof portion 26 having a closeable access opening 27 disposed on the centerline of the vehicle between the second and third axle positions. The body further is provided with front, rear and side panels extending from such opening to the floor of the vehicle body, defining an engine compartment adapted to receive power plant module 23. The module is adapted to be inserted into such engine compartment and removed therefrom through access opening 27 as illustrated in FIG. 5.

Power plant module 23 generally consists of a support structure 28, an engine 29, a transmission 30 and a transfer case 31. The support structure generally consists of a rigid frame formed of tubular members having a rectangular configuration, including a set of vertically disposed leg members 32 rigidly connected by a set of crosspiece members including a lower crosspiece member 33, an intermediary crosspiece member 34 and an upper crosspiece 35. Supported on one of the leg members and projecting laterally therefrom is a substantially triangularly configured bracket 36 supporting a bottom panel member 37 also supported on a crosspiece member and an inclined panel 38 having a circular opening 39, also supported at its lower end on bottom panel member 37. Mounted on the outer side of inclined panel member 38 is a pair of adjustable struts 40 and 41 which support a grille 42 provided with openings communicating with opening 39. The intermediary crosspiece member 34 further is provided with a set of motor mounts 43.

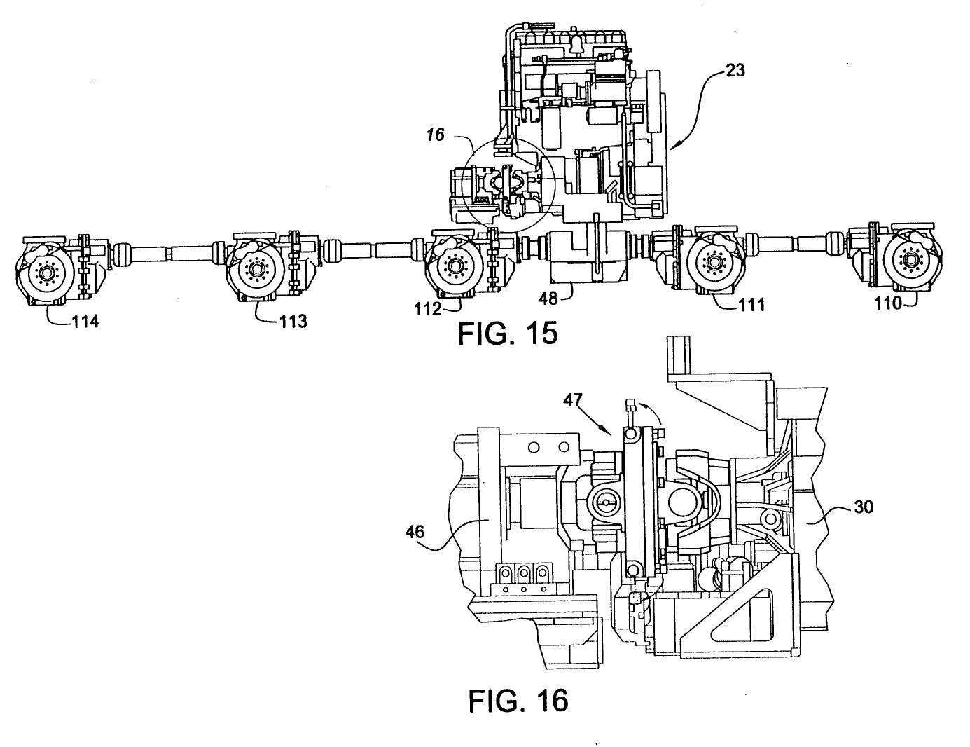

Engine 29 preferably is a diesel engine having sufficient horsepower to drive the vehicle, its systems and components. It is mounted on engine mounts 43 within the upper end of and supported by the support structure. It further may consist of an internal combustion gas engine or a gas turbine. Transmission 30 is mounted on the underside of the engine within the support structure, and supported in depending relation therefrom. Drive from the engine to the transmission is provided by transfer case 31 which essentially consists of a gear train interconnecting the output shaft of the engine to the input shaft of the transmission. Operatively connected to such gear train is a set of hydraulic pumps 44 and 45 used to operate various hydraulic systems on the vehicle and lubricate various operating components including the transfer cases transferring drive from the transmission to the propeller shafts of the driveline. When the power plant module is positioned in the engine compartment of the vehicle, the output shaft of the transmission may be disconnectably coupled to a second transfer case 36 through a coupling assembly 47 as best seen in FIGS. 15 and 16. Drive from transfer case 46 is then transferred through a third transfer case 47, which functions to divide drive forwardly and rearwardly to the differentials of axle assemblies in the second and third axle positions.

In lieu of an engine and transmission combination, a hybrid drive consisting of an engine and an electric motor or motor-generator set may be mounted on the support structure. Such a drive would allow the vehicle to be easily and quickly converted from a conventional drive to a hybrid drive.

Transfer case 46 also includes an input shaft drivingly connectable to the output shaft of the transmission through coupling assembly 47, and means operable to transmit first and second drives and place the vehicle in neutral for towing. Transfer case 48 similarly consists of a gear train operatively interconnecting an input shaft and a pair of longitudinally disposed output shafts. Transfer cases 31, 46 and 48 are disposed within the interior of the hull with transfer case 48 being disposed at a lower end of the hull between the second and third axle positions. Transfer case 48 also includes a parking brake.

Access opening 27 in the roof portion of the vehicle body is adapted to be closed by one or more hinged panels including an air intake grille 49 as best shown in FIG. 5. The module further is provided with an upper panel member 50, a radiator 51 mounted on the side of the support structure and operatively connected to the engine, and a fan 52 supported on inclined panel 38 aligned with circular opening 39 and operatively connected to the engine. When the module is positioned in the engine compartment, the upper end thereof will be spaced from the closed access opening including the air intake grille, the rear end of the module will be spaced from the rear wall of the compartment to provide a space partially occupied by the radiator and the side of the engine including the fan will be spaced from a side wall of the compartment. In such an arrangement, when the engine is operated and fan 52 is operating, fan 52 will operate to draw air through air intake grille 49, pass it through the spaces between the upper end of the module and the roof portion of the vehicle, between the engine and the rear wall of the engine compartment through radiator 51, and between the engine and a side wall of the engine compartment, and exhausted along with exhaust gases of the engine through exhaust grille 42. Such airflow functions not only to cool the engine and transmission but to mix the exhaust gases of the engine with the cooling airflow. Structurally, exhaust grille 42 forms a portion of the envelope of the vehicle body as shown in FIG. 1.

Coupling assembly 47 shown in FIGS. 16 through 18, generally consists of a pair of mating discs 60 and 61 drivingly interconnecting the output shaft of the transmission and the input shaft of transfer case 46 through a set of Cardan joints. Disc 60 consists of a base plate 62 on which there is bolted an outer plate 63 provided with a set of ear portions 64 and 65 defining a yoke forming a portion of the universal joint drivingly interconnecting the output shaft of the transmission and the coupling assembly. Disc 61 includes a base plate 66 adapted to mate with base plate 62 and an outer plate 67 having a pair of ear portions 68 and 69 forming a yoke and providing a mounting means for the universal joint drivingly interconnecting coupling assembly 47 and the input shaft of transfer case 46.

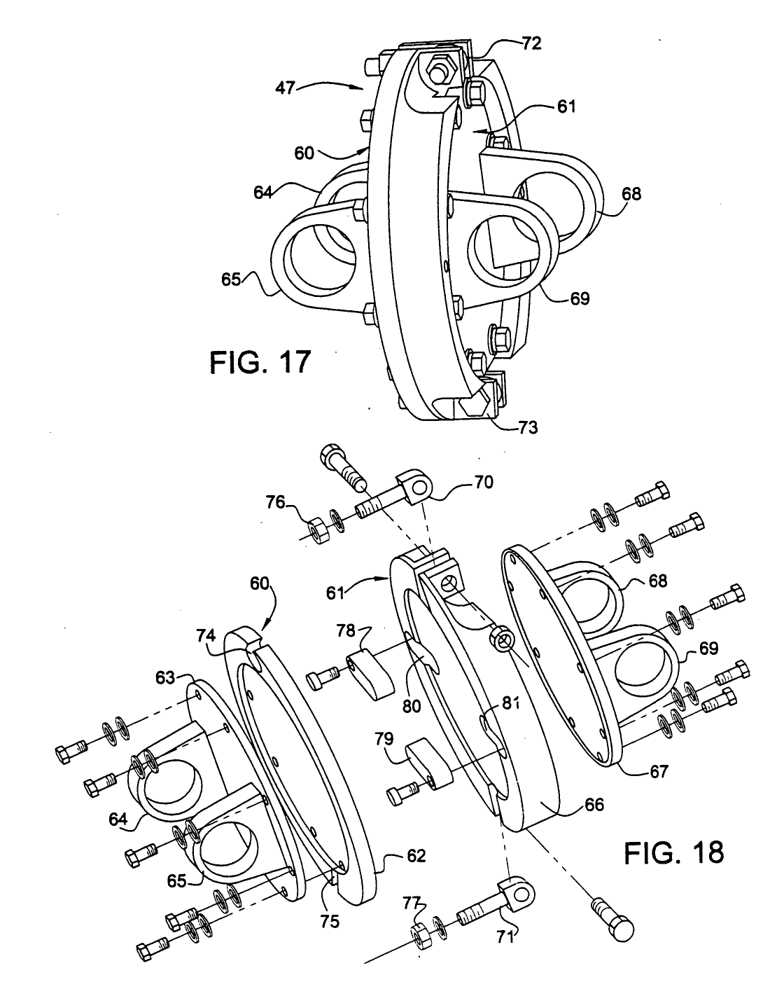

Coupling discs 60 and 61 are adapted to be disconnectably secured together in mating relation by means of a set of toggle bolts 70 and 71 pivotally connected to sets of ear portions 72 and 73 of base plate member 66, having shank portions receivable within a pair of radially disposed slots 74 and 75 in base plate member 62 and secured therein by means of a set of nuts 76 and 77 threaded on the ends of the toggle bolts and drawn up against the outer surface of base plate member 62. Drive between mating discs 60 and 61 is provided by a pair of face key members 78 and 79 spaced diametrically and disposed radially relative to the axis of the coupling assembly, which are secured to base plate member 66 and received within a pair of registrable openings 80 and 81 provided in the mating surface of base plate member 62. It will be appreciated that when the coupling assembly as described is in the assembled condition as shown in FIG. 17 and interconnects the output shaft of the transmission and input shaft of transfer case 46 as shown in FIG. 16, drive will be transmitted from the transmission shaft through a first universal joint, the coupling assembly, a second universal joint and the input shaft of transfer case 46 to transmit drive therebetween. Upon disconnecting disc member 60 from disc member 61 by backing off but not removing nuts 76 and 77, pivoting toggle bolts 70 and 71 out of recesses 74 and 75 and separating the disc members, the output shaft of the transmission and the input shaft of transfer case 46 will be quickly and easily uncoupled to permit the power plant module to be removed from the engine compartment of the vehicle. To permit such displacement, a portion of the universal joint between the coupling assembly and transfer case 46 is provided with a splined connection permitting the axial displacement of the coupler components.

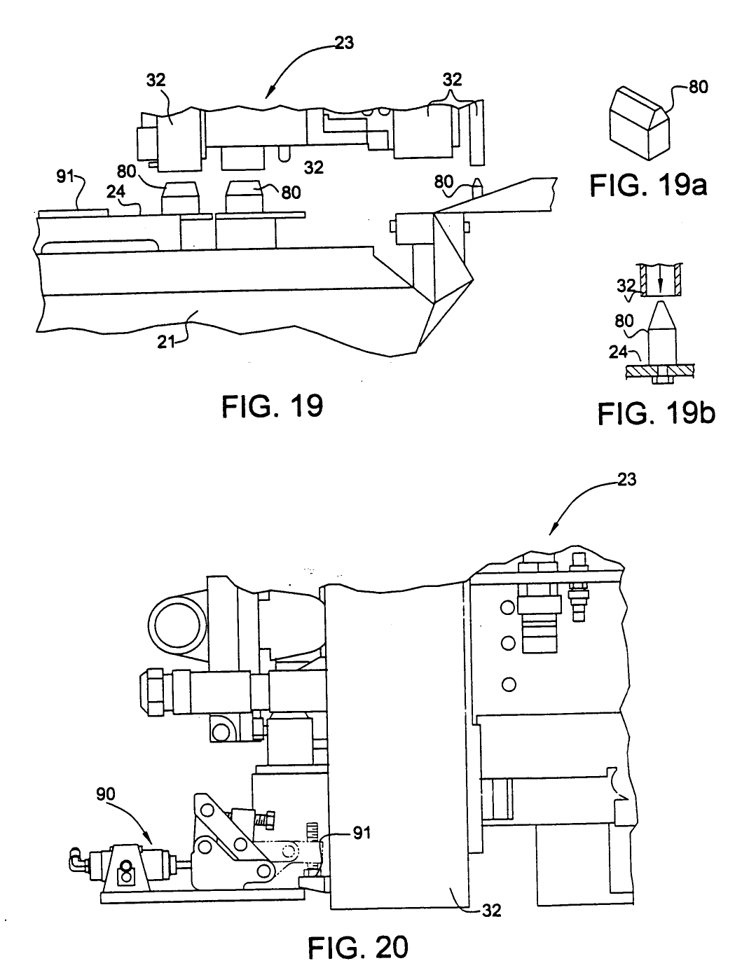

To properly align the mating components of coupler assembly 47 and thus permit the coupler assembly to be connected for transmitting drive from the transmission to transfer case 46, the power plant module must be precisely positioned within the engine compartment of the vehicle. Such precise positioning is achieved by means of a set of four positioning members 80 secured to the floor of the vehicle within the engine compartment, projecting upwardly and adapted to be received within the lower openings in leg members 32 of the support structure as indicated in FIG. 19 to guide the legs into position. Each of positioning members 80 is provided with an upper beveled surface so that whenever the leg portions of the support structure are aligned vertically with members 80 as shown in FIG. 19, and the support structure is lowered, the upper ends of members 80 will be received within the lower openings of the leg sections to guide the support structure downwardly to a position aligning one mating portion of the coupling assembly with the other portion of the coupling assembly to thus permit such portions to be coupled together.

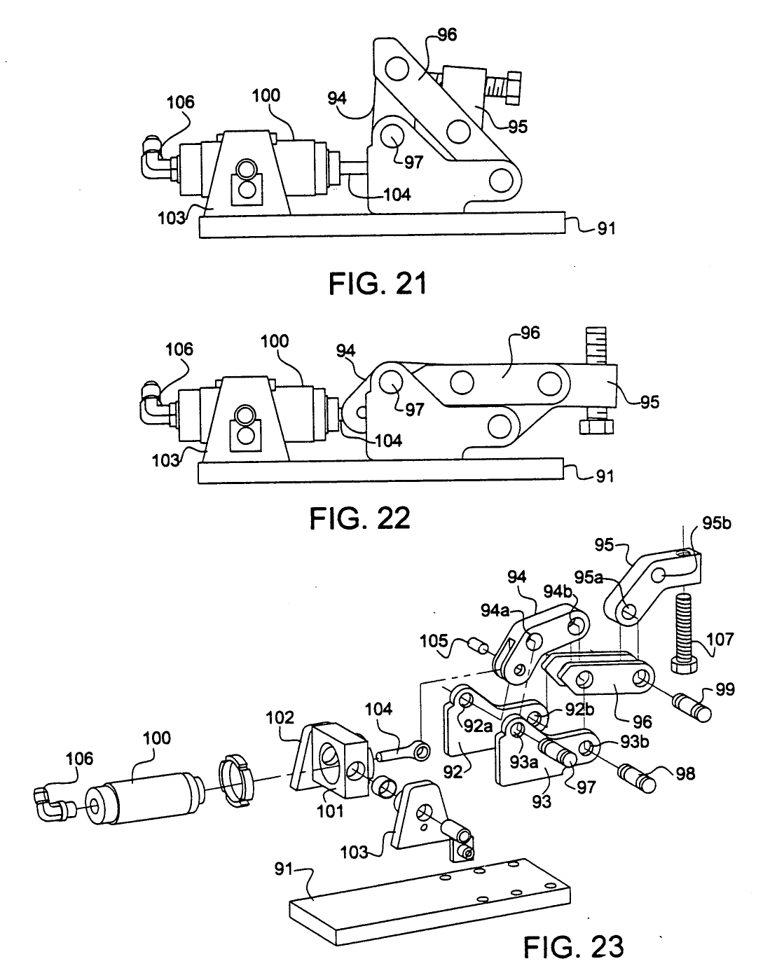

Once the power plant module is properly positioned within the engine compartment of the vehicle through the use of guide members 80, the module may be detachably secured to the floor of the vehicle by means of several retainer mechanisms 90 mounted on the floor of the vehicle within the engine compartment, each of which cooperates with a lip portion 91 formed at a lower end of a leg member of the support structure. As best illustrated in FIGS. 21 through 23, each of such mechanisms consists of a four bar linkage type arrangement pivoted into different positions by a cylinder assembly having a rod member biased in a retracted position by a spring and extendable by the supply of fluid under pressure to one end thereof. The mechanism specifically includes a base plate 91 secured to the floor of the vehicle body adjacent a guide plate 80 adapted to be received within a leg member of the support structure when such structure is installed within the engine compartment of the vehicle, a pair of spaced brackets 92, 93 rigidly mounted on and secured to the base plate, and a set of pivotal links 94, 95 and 96. Link 94 is pivotally connected to brackets 92 and 93 by means of a pin 97 which is inserted through openings 92a and 93a of brackets 92 and 93 and intermediate opening 94a of link 94. Link 95 is pivotally connected to brackets 92 and 93 by means of a pin 98 inserted through openings 92b and 93b of brackets 92 and 93 and opening 95a of link 95. Link 96 is pivotally connected to link 95 by means of a pin 99 inserted through one set of openings in link 96 and opening 95b in link 95 and a pin inserted in an opposite set of openings in link 96 and opening 94b in link 94.

Fluid actuated cylinder 100 is supported in a block 101 pivotally connected to a pair of brackets 102 and 103 rigidly mounted on base plate 91. The cylinder assembly has rod member 104 pivotally connected to a free end of link 94 by means of a pin 105. Cylinder member 100 is provided with an internal spring which functions to bias rod member 104 in a retracted position, and a fitting 106 connected through a hose to a source of fluid under pressure.

The spring within cylinder 100 biasing rod member 104 in a retracted position has the effect of pivoting link 94 in a clockwise direction and correspondingly link 95 in a clockwise direction to position link 95 in the position as shown in FIG. 22 so that the head of a bolt 37 threaded into an opening on the free end of link 95 will be caused to engage the upper surface of an adjacent lip 91 of a leg member of the support structure to clamp such leg and correspondingly the support structure to the floor of the vehicle body. When fluid under pressure is supplied to the base end of cylinder 100, links 94 and 95 will be caused to pivot relative to brackets 92 and 93 in a counterclockwise direction to position link 95 in the position shown in FIG. 21, and the head of bolt 107 out of clamping relation with lip 91. The springs in the conduits 100 of the retaining mechanisms 90 function to normally extend links 95 thereof into clamping positions as shown in FIG. 22, and only when fluid under pressure is applied to the base ends of such cylinders will links 95 be pivoted out of clamping relationship with adjacent leg portions of the support structure to free the support structure for removal purposes.

To remove the power plant module from the vehicle, the upper panel covering the engine compartment is opened to expose the module, coupling assembly 47 is disconnected to uncouple the power plant from the driveline of the vehicle, various hydraulic and electrical lines are disconnected from the power plant, a hook of a hoisting cable is connected to an eye bolt provided on the module, fluid under pressure is supplied to the base ends of the cylinders of the various retaining mechanisms to free the module from the vehicle and the module is then hoisted out of the vehicle and positioned on the ground adjacent the vehicle for maintenance, repair or replacement purposes. The support structure of the module functions as a service stand outside the vehicle providing easy access to the engine and transmission or hybrid drive mounted on the underside of the engine. The serviced or repaired module or a replacement module may then be inserted into the vehicle by hoisting the module, positioning it above the engine compartment, lowering the module with the leg portions thereof vertically aligned with guide plates 80, resting the module on the floor of the vehicle within the engine compartment and then discontinuing the supply of fluid under pressure to the cylinders of the restraining mechanisms to allow them to reengage the lip portions of the support legs in clamping relation to secure the module to the body of the vehicle. When only minor repairs or adjustments to the engine, transmission or any components thereof may be required, access thereto may be obtained by removal of one or more walls of the engine compartment or through access openings provided in the wheel wells of the vehicle adjacent the module.

FIG. 15 illustrates the position of the power plant relative to the driveline of a vehicle having a 10×10 wheel configuration. The driveline includes axle carriers 110 through 114 which are disposed on the exterior underside of the vehicle within the transverse recesses in the hull defining axle positions 1 through 5, and are secured to and depend from transversely disposed panels of the hull by bolts or other suitable means. The power plant is positioned between axle positions 2 and 3. Carrier 112 is disposed in the third axle position rearwardly of transfer case 48, has an input shaft drivingly connected to transfer case 48 by means of a short shaft. Carrier 111 is disposed immediately forwardly of transfer case 48 in the second wheel position, and is provided with an input shaft drivingly connected to an output shaft of transfer case 48. Carrier 113 is disposed rearwardly of carrier 112, in the fourth axle position, and is drivingly connected to carrier 112 by means of a drive shaft drivingly interconnecting the output shaft of carrier 112 and the input shaft of carrier 113. Carrier 110 is disposed forwardly of carrier 111, in the first axle position, and is drivingly connected to carrier 111. Carrier 114 is disposed rearwardly of carrier 113, in the fifth axle position, and is drivingly connected to carrier 113 by a drive shaft.

Transfer case 48 includes means for providing inter-axle differential drive. Carriers 111, 112 and 113 also include gearing arrangements providing for inter-axle differential drive. All of the carriers include means for providing inter-wheel drive. Each of the carriers is provided with transversely projecting half shafts drivingly connected to the wheels of an associated wheel unit and further is provided with a set of disc brake assemblies.

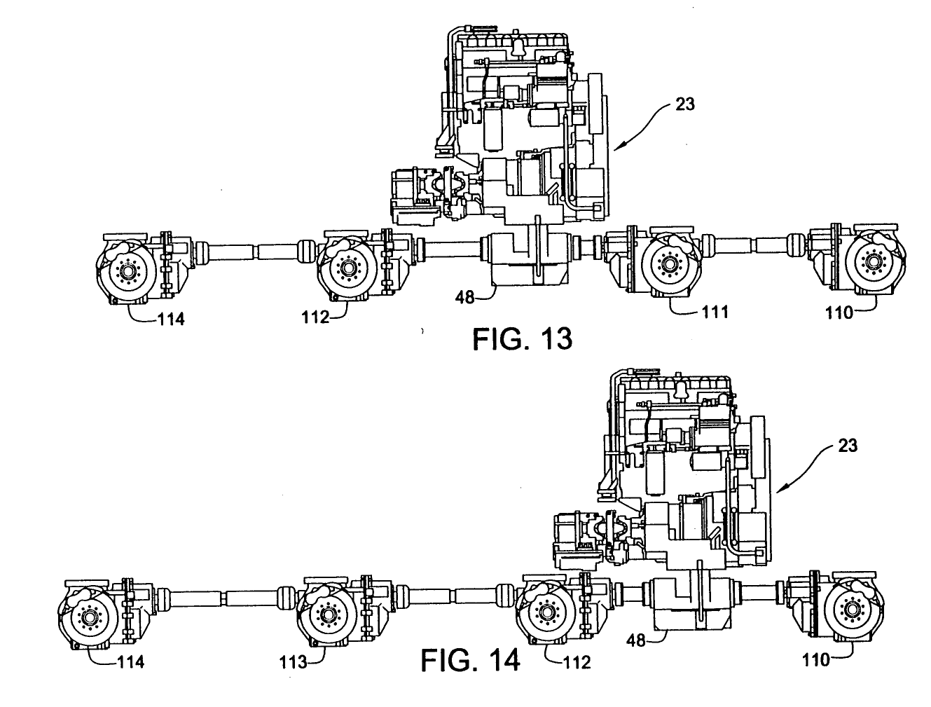

The power plant and driveline arrangement shown in FIG. 15 may easily be modified to accommodate a vehicle having an 8×8 wheel configuration simply by eliminating carrier 113 and coupling carrier 114 to carrier 112 to provide the configuration shown in FIG. 13. In such arrangement, carriers 110, 111, 112 and 114 would be disposed in wheel positions 1 through 4, respectively, and the power plant would be positioned between the second and third axle positions. Alternatively, carrier 111 may be eliminated. In such alternate arrangement, carriers 110, 112, 113 and 114 would be disposed in wheel positions 1 through 4, respectively, and the power plant would be positioned between the first and second wheel positions, as shown in FIG. 14.

To further modify the arrangement shown in FIG. 15 to accommodate a vehicle having a 6×6 configuration, carriers 111 and 113 would be omitted. In such arrangement, carriers 110, 112 and 114 would be disposed in the first, second and third axle positions, respectively, and the power plant would be mounted on the vehicle between the first and second wheel positions as shown in FIG. 12.

To still further modify the arrangement shown in FIG. 15 to accommodate a vehicle having a 4×4 configuration, carriers 111, 112 and 113 would be omitted. In such arrangement, carriers 110 and 114 would be disposed and axle positions 1 and 2, respectively, and the power plant would be positioned between them.

The arrangement as described, provides a simple, expedient and efficient method of obtaining access to the power plant of a vehicle for maintenance, repair or replacement purposes. It allows for minor maintenance and repair of the power plant mounted within the vehicle body and major maintenance and repair with the power plant removed and therefore more accessible. It further provides for a support structure for the power plant removed from the vehicle, which facilitates performing various maintenance and repair operations on the unit.

From the foregoing detailed description, it will be evident that there are a number of changes, adaptations, and modifications of the present invention which come within the province of those persons having ordinary skill in the art to which the aforementioned invention pertains. However, it is intended that all such variations not departing from the spirit of the invention be considered as within the scope thereof as limited solely by the appended claims.

We claim:

1. A vehicle comprising:
a set of wheel assemblies;
a body mounted on said wheel assemblies;
a steering system mounted on said body and operatively connected to at least one of said wheel assemblies;
a module removably mounted on said body including a support structure and a power plant mounted on said support structure; and
means for transferring drive from said power plant to at least one of said wheel assemblies when said module is mounted on said body, including means for disconnecting said power plant from said drive transferring means.

2. A vehicle according to claim 1 wherein said module is mountable on the longitudinal centerline of said body.

3. A vehicle according to claim 1 wherein said module is mountable within said body, and said body includes an access opening through which said module may be inserted into and removed from said body.

4. A vehicle according to claim 1 wherein said power plant includes an engine and a transmission, and said drive transferring means includes means for coupling an output shaft of said transmission to an input shaft of said drive transferring means.

5. A vehicle according to claim 4 wherein said transmission is disposed beneath said engine, and including means for transferring drive from said engine to said transmission.

6. A vehicle according to claim 5 wherein said engine is a diesel engine and said transmission is automatic.

7. A vehicle according to claim 1 wherein said module is mountable on said body between a set of wheel assemblies.

8. A vehicle according to claim 1 wherein said body includes a closed power plant compartment having air intake and exhaust openings, and said module is mountable therein.

9. A vehicle according to claim 1 wherein said body includes a closeable opening through which a portion of said power plant may be accessed.

10. A vehicle according to claim 9 wherein said opening is disposed in a wheel well of said body.

11. A vehicle according to claim 1 wherein said body is of a monocoque construction.

12. A vehicle according to claim 1 including means supported on said body and cooperable with said support structure for guiding said module into a selected position on said body.

13. A vehicle according to claim 1 including means supported on said body and cooperable with said support structure for detachably securing said module in a selected position on said body.

14. A vehicle according to claim 11 wherein an access door is provided in a roof section of said body through which said module may be lifted and lowered in removing and inserting said module out of and into said body.

15. A vehicle according to claim 14 wherein said access door includes an air intake grille.

16. A vehicle according to claim 11 wherein said support structure of said module includes an intake grille which forms a section of said body when said module is mounted in said body.

17. A vehicle according to claim 11 wherein said body includes a closed compartment in which said module is mounted, said compartment includes an air intake and an exhaust outlet whereby air introduced through said intake is caused to flow through said compartment and be exhausted through said outlet.

18. A vehicle according to claim 17 including a fan disposed in said compartment for exhausting air therefrom.

19. A vehicle according to claim 11 wherein said body includes a closed compartment in which said module is mounted, said compartment includes walls spaced from said module having an air intake and an exhaust opening providing an air passageway from said intake, past said power plant and through said exhaust opening, and including a radiator in said air passageway.

20. A vehicle according to claim 19 including a fan disposed between said radiator and said exhaust.

21. A vehicle according to claim 20 wherein said air intake comprises a grille formed as a portion of said body, said radiator is supported on said support structure and said exhaust opening comprises a grille formed as a portion of said body.

22. A vehicle according to claim 21 including a fan supported on said support structure disposed between said radiator and said exhaust opening.

23. A vehicle according to claim 1 wherein said vehicle has a 4×4 wheel configuration and said module is mountable between the first and second wheel positions thereof.

24. A vehicle according to claim 1 wherein said vehicle has a 6×6 wheel configuration and said module is mounted between the first and second wheel positions thereof.

25. A vehicle according to claim 1 wherein said vehicle has an 8×8 wheel configuration and said module is mounted between first and second wheel positions thereof.

26. A vehicle according to claim 1 wherein said vehicle has an 8×8 wheel configuration and said module is mounted between second and third wheel positions thereof.

27. A vehicle according to claim 1 wherein said vehicle has a 10×10 wheel configuration and said module is mounted between second and third wheel positions thereof.

28. A module removably mountable on a vehicle having a set of wheel assemblies, a body mounted on said wheel assemblies, a steering system mounted on said body and operatively connected to at least one of said wheel assemblies and a driveline operatively connected to at least one of said wheel assemblies, comprising:
a support structure removably mountable on said body;
a power plant mounted on said support structure; and
disconnectable means for coupling said power plant to said driveline when said module is mounted on said body.

29. A module according to claim 28 wherein said power plant includes an engine and a transmission, and said coupling means includes means for coupling an output shaft of said transmission to an input shaft of said driveline.

30. A module according to claim 29 wherein said transmission is disposed beneath said engine, and including means for transferring drive from said engine to said transmission.

31. A vehicle according to claim 30 wherein said support structure includes a frame having crosspiece members and said engine is supported on engine mounts disposed on said crosspiece members.

32. A module according to claim 29 wherein said engine is a diesel engine and said transmission is automatic.

33. A module according to claim 28 including means disposed on said support structure cooperable with means disposed on said body for guiding sand module into a selected position on said body.

34. A module according to claim 28 including means disposed on said support structure cooperable with means disposed on said body for detachably securing said module o said body.

35. A module according to claim 28 including a radiator.

36. A module according to claim 28 including an exhaust grille mounted on said support structure.

37. A module according to claim 28 including a fan mounted on said support structure.

38. A module according to claim 28 including a radiator and exhaust grille mounted on said support structure and a fan mounted on said support structure between said radiator and said exhaust grille.

39. A module according to claim 28 wherein said support structure comprises a frame including a set leg members opened at the lower ends thereof.

40. An assembly for coupling a pair of coaxially aligned drive and driven shafts, comprising:
a first member having means for drivingly connecting to one of said shafts, a mating surface and at least one recess provided in said mating surface;
a second member having means for drivingly connecting to the other of said shafts, a mating surface engageable with the mating surface of said first member and a protrubuance on said mating surface thereof receivable in said recess of said first member when said mating surfaces engages, for transferring torque between said members; and
means for detachably securing said members together with their mating surfaces engaging.

41. An assembly according to claim 40 wherein each of said connecting means comprises a yoke portion of a universal connection with an adjacent one of said shafts.

42. An assembly according o claim 40 wherein said first member includes a pair of recesses diametrically spaced relative to an axis coaxiable with the axis of said shafts when said members are coupling said shafts, and said second member includes a pair of protruberances receivable in said recesses of said first member when said mating surfaces engage, for transferring torque between said members.

43. An assembly according to claim 40 wherein said detachably securing means comprises at least one toggle bolt pivotably connected to one of said members and having a nut threaded on a free end thereof, and a plate having a notch in an end thereof mounted on the other of said members in which notch a portion of said bolt may be received and against which plate said nut may be drawn to secure said members together.

44. A mechanism for releasably retaining a first structure having a bearing surface in engagement with a second structure, comprising:
a four bar linkage having a stationary bar secured to said second structure and an angularly, displaceable bar engageable with aid bearing surface of said first structure when a bar of said linkage is angularly displaced relative to an adjoining bar; and
means for angularly displacing one of the angularly displaceable bars of said linkage.

45. A mechanism according to claim 44 wherein said displacing means comprises a fluid actuated cylinder assembly having a rod member operatively connected to said one angularly displaceable bars.

46. A mechanism according to claim 45 wherein said cylinder includes a spring biasing sand rod member in a first direction for urging said linkage in a first condition and means for supplying a fluid under pressure for driving said rod member in a direction opposite of said first direction for displacing said linkage into a second condition.

47. A mechanism according to claim 44 wherein one of said angularly displaceable bars includes a portion projecting beyond a pivotal connection of said one bar with an adjoining bar, another of said angularly displaceable bars includes a portion projecting beyond a pivotal connection of said another bar with an adjoining bar, engageable with said bearing surface upon angular displacement of said another bar, and said displacing means comprises a fluid actuated cylinder assembly having a rod member pivotally connected to said projected portion of said one angularly displaceable bar.

48. A mechanism according to claim 47 wherein said cylinder assembly includes a spring biasing said rod member into a retracted position and thus causing said another angularly displaceable bar to angularly displace and the extended portion thereof to engage said bearing surface of said first structure in clamping relation therewith, and means for selectively supplying fluid under pressure to said cylinder assembly for driving said rod to an extended position and thus causing said another angularly displaceable bar to angularly displace and the extended portion thereof to disengage said bearing surface of said first structure, out of clamping relative therewith.

49. A mechanism according to claim 48 wherein said projecting portion of said another angularly displaceable bar includes a threaded member having a free end engageable with said bearing surface of said first structure.

50. A vehicle according to claim 1 wherein said power plant comprises a hybrid drive including an engine and an electric motor.

51. A module according to claim 28 wherein said power plant comprises a hybrid drive including an engine and an electric motor.

52. A module according to claim 28 wherein said support structure may be supported on a surface outside the vehicle permitting said power plant to be accessed for repair, maintenance or replacement purposes.

53. A module according to claim 1 wherein said power plant comprises a hybrid drive including an engine mounted on said support structure and an electric motor mounted on the underside of said engine.

54. A module according to claim 53 wherein said engine is a diesel engine.

55. A module according to claim 53 wherein said engine is an internal combustion engine.

56. A module according to claim 53 wherein said electric motor comprises an electric motor-generator set.
